(19) United States
(12) Patent Application Publication
(10) Pub. No.: US 2016/0292923 A1
(43) Pub. Date: Oct. 6, 2016

(54) SYSTEM AND METHOD FOR INCORPORATING A PHYSICAL IMAGE STREAM IN A HEAD MOUNTED DISPLAY

(71) Applicant: SULON TECHNOLOGIES INC., Markham (CA)

(72) Inventors: Dhanushan BALACHANDRESWARAN, Richmond Hill (CA); Zexi CHEN, Toronto (CA); Jian ZHANG, Oakville (CA)

(21) Appl. No.: 15/026,890

(22) PCT Filed: Oct. 3, 2014
(86) PCT No.: PCT/CA2014/050958

§ 371 Date: Apr. 1, 2016

Related U.S. Application Data
(60) Provisional application No. 61/886,443, filed on Oct. 3, 2013.

(51) Int. Cl. G06T 19/00; G02B 27/01; G06T 3/00; G06T 7/00

(52) U.S. Cl. CPC G06T 19/006; G06T 7/004; G02B 27/0172; G06T 3/0081; G06T 2207/20021; G06T 2207/20221; G02B 2027/014; G02B 2027/0138; G02B 2027/0187; G06T 2207/30244

(57) ABSTRACT

An augmented reality and virtual reality head mounted display is described. The head mounted display comprises a processor to initiate display of an image stream of its physical surroundings, enabling equipped with the head mounted display to view the physical environment.

### TECHNICAL FIELD

The following relates generally to systems and methods for augmented and virtual reality environments, and more specifically to systems and methods for displaying physical environment in the display of a head mounted device.

### BACKGROUND

The range of applications for augmented reality (AR) and virtual reality (VR) visualization has increased with the advent of wearable technologies and 3-dimensional (3D) rendering techniques. AR and VR exist on a continuum of mixed reality visualization.

### SUMMARY

In embodiments, a method for simultaneously displaying, in a head mounted display disposed upon a user in a physical environment, a physical image stream of a captured region of the physical environment captured within the field of view an imaging system of the head mounted display, and an augmented reality rendered image stream generated by a processor for the physical environment. The method comprises: determining the captured region; generating a rendered image stream for a region of a map of the physical environment at least partially corresponding to the captured region; simultaneously receiving and displaying the physical image stream and the rendered image stream on a display system of the head mounted display.

In embodiments, a system is described for matching an augmented reality rendered image stream to a physical image stream of a region of a physical environment captured in the field of view of an imaging system of an HMD. The system comprises a processor configured to: obtain a map of the physical environment; determine the captured region; generate a rendered image stream for a region of the map at least partially corresponding to the captured image stream.

These and other embodiments are described herein.

### DESCRIPTION OF THE DRAWINGS

A greater understanding of the embodiments will be had with reference to the Figures, in which:

FIG. 1 illustrates an embodiment of a head mounted display (HMD) device;

FIG. 2 illustrates a field of view of a camera lens and image sensor of an HMD;

FIG. 3 is a flowchart of a method for watermark overlaying of a rendered image stream onto a physical image stream;

FIG. 4 is a diagram of a user equipped with an HMD in a physical environment;

FIG. 5A illustrates an exemplary frame in an image stream of a physical environment;

FIG. 5B illustrates an exemplary frame in a rendered image stream for a physical environment;

FIG. 5C illustrates an exemplary frame of a combination of a physical image stream and a corresponding rendered image stream;

FIG. 6 is flowchart illustrating a method for simultaneously displaying a rendered image stream and a physical image stream in discrete areas of a display system; and

FIG. 7 illustrates an exemplary picture-in-picture combination of a rendered image stream and a corresponding physical image stream.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media and executed by the one or more processors.

The present disclosure is directed to systems and methods for augmented reality (AR). However, a skilled reader will appreciate that the term “AR” may encompass several meanings. In the present disclosure, AR includes: the interaction by a user with real physical objects and structures along with virtual objects and structures overlaid thereon; and the interaction by a user with a fully virtual set of objects and structures that are generated to include renderings of physical objects and structures and that may comply with scaled versions of physical environments to which virtual objects and structures are applied, which may alternatively be referred to as an “enhanced virtual reality”. Further, the virtual objects and structures could be dispensed with altogether, and the AR system may display to the user a version of the physical environment which solely comprises an image stream of the physical environment. Finally, a skilled reader will also appreciate that by discarding aspects of the physical environment, the systems and methods presented herein are also applicable to virtual reality (VR) applications, which may be understood as “pure” VR. For the reader's convenience, the following refers to “AR” but is understood to include all of the foregoing and other variations recognized by the skilled reader.

User engagement in an AR system may be enhanced by allowing a user to move throughout a physical space in an unconstrained manner. It will be appreciated, however, that a user equipped with a head mounted display (HMD) is preferably aware of obstacles within the physical environment in order to move about it and not accidentally make contact with the obstacles.

Thus, user engagement and user safety for an AR system may be enhanced by displaying substantially real-time images of at least part of the physical environment to the user on an HMD.

Systems and methods are described herein for displaying parts of a physical environment on the HMD of a user occupying the physical environment.

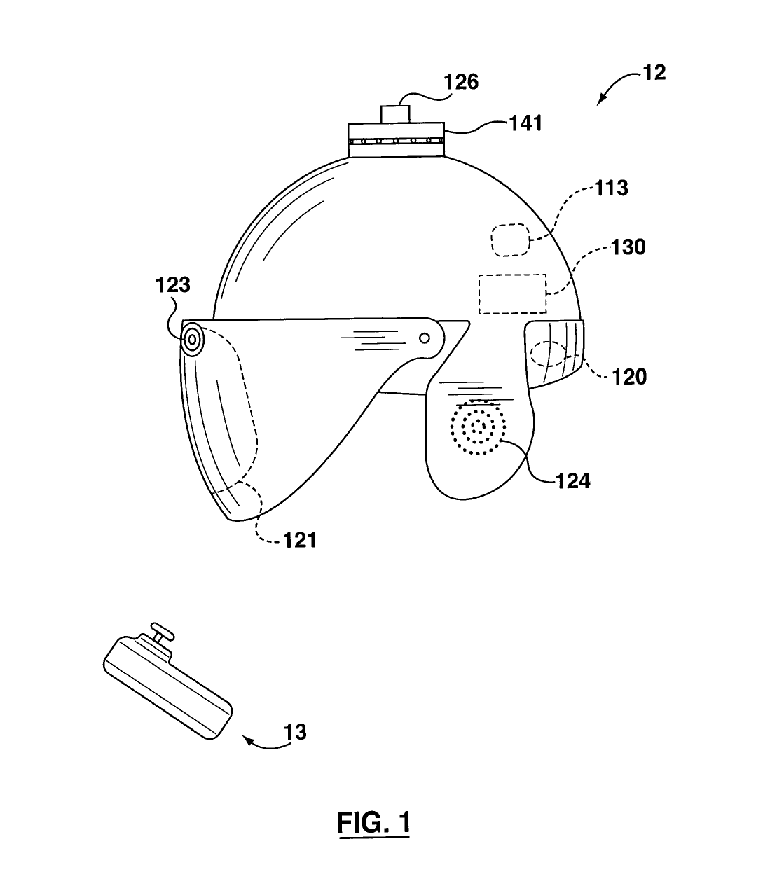

Referring now to FIG. 1, an exemplary HMD 12 configured as a helmet is shown; however, other configurations are contemplated. The HMD 12 may comprise: a processor 130 in communication with one or more of the following components: (i) a scanning, local positioning and orientation module 141 comprising a scanning system for scanning the physical environment, a local positioning system for determining the HMD 12′s position within the physical environment, and an orientation detection system for detecting the orientation of the HMD 12; (ii) at least one imaging system, such as, for example, a camera system comprising one or more cameras 123, to capture image streams of the physical environment; (iii) at least one display system 121 for displaying to a user of the HMD 12 the AR and/or VR and the image stream of the physical environment; (iv) at least one power management system 113 for distributing power to the components; (v) sensory feedback systems comprising, for example, of haptic feedback devices 120, for providing sensory feedback to the user; and (vi) an audio system 124 with audio input and output to provide audio interaction. The processor 130 may further comprise a wireless communication system 126 having, for example, antennae, to communicate with other components in an AR and/or VR system, such as, for example, other HMDs, a gaming console, a router, or at least one peripheral 13 to enhance user engagement with the AR and/or VR;. These and other systems and components are described herein, and in Applicant's co-pending PCT Application No. PCT/CA2014/050905, the entire disclosure of which is incorporated herein by reference. It will be appreciated that the term “processor” as used herein is contemplated as being implemented as a single processor or as multiple distributed and/or disparate processors in communication with components and/or systems requiring the processor or processors to perform tasks.

A user equipped with the HMD 12 and situated in a physical environment may move about, and interact with, the physical environment while viewing a VR on the display system 121 of the user's HMD 12.

In certain AR applications, the user simply views an entirely rendered environment bearing no relation to the physical environment (i.e., a “pure” VR application). In such applications, then, the user's engagement with the physical environment may be purely as a space within which to move. For example, in an application in which the user exercises, the physical environment may serve as a platform within which the user may perform calisthenics, aerobics, resistance training or other suitable exercises. The AR displayed to the user, then, may not account for obstacles within the physical space. However, the user may wish or need to view the physical space in substantially real-time to ensure that she does not encounter obstacles or boundaries within the physical environment and thereby sustain an injury. The present system and method enables the user to view the physical environment simultaneously as interacting with the VR rendered environment notwithstanding that the VR environment itself need not account for the physical environment.

In other applications, however, the user views an AR comprising a completely rendered version of the physical environment (i.e., “enhanced VR”). In such applications, the user may determine the locations for obstacles or boundaries in the physical environment based solely on the rendering displayed to her in the display system 121 of her HMD 12. However, the user may still need or prefer to view a substantially real-time image stream of the physical environment.

In still other applications, the user views an AR comprising computer-generated renderings (a “rendered image stream”) in conjunction with an image stream of the physical environment (a “physical image stream”). In such applications, the user may still need or wish to view a substantially real-time physical image stream free of rendered effects.

The HMD 12 may therefore implement one or more techniques to display a substantially real-time image stream of the physical environment (a “physical image stream”) to the user. In aspects, the HMD 12 may invoke picture-in picture (PIP), picture-outside-picture, picture and picture, or multi-display techniques to display the physical image stream to the user, as described herein in greater detail. In further aspects, the HMD 12 may implement watermark overlapping to display the physical image stream to the user, as described herein in greater detail. It will be appreciated that in pure VR applications, the physical image stream and the rendered image stream are entirely unrelated. However, in AR and enhanced VR applications, the rendered image stream is based on the physical environment. In such applications, the processor preferably matches the rendered image stream to the rendered image stream, as described herein.

In AR and enhanced VR applications, the HMD may display both the rendered and physical image streams to the user, either using PIP and related techniques, or by combining the rendered and physical image streams for display.

The HMD 12 invokes the systems in the scanning, positioning and orientation determining module 141 in conjunction with the processor 120 to, respectively, scan and map the physical environment, obtain real time positioning for the HMD 12 within the physical environment, and determine the orientation of the HMD 12. The systems in the scanning, positioning and orientation determining module 141 may comprise one or more of: a scanning laser range finder (SLRF), which may constitute the scanning and local positioning systems; a laser positioning system having a laser emitter and/or receiver configured to determine the position of the HMD 12 with respect to correspondingly opposite laser receivers or emitters located at known locations throughout the physical environment; a 3-axis magnetic orientation system having a 3-axis magnetic source or sensor configured to determine the location and/or orientation of the HMD 12 with respect to a correspondingly opposite 3-axis magnetic sensor or source having a known orientation and location within the physical environment.

The processor 130 may map the physical environment by generating a virtual map, such as, for example, a point cloud, of the physical environment using measurements of the physical environment provided by the scanning system. The processor 130 may assign a coordinate system based on world coordinates to the map of the physical environment. The processor 130 further generates AR renderings for the map, such as, for example, virtual objects, effects, characters and/or other suitable CGI. The processor associates all points in the AR rendered image stream with the physical environment map, such that it is operable to associate AR rendered images with particular regions of the physical environment.

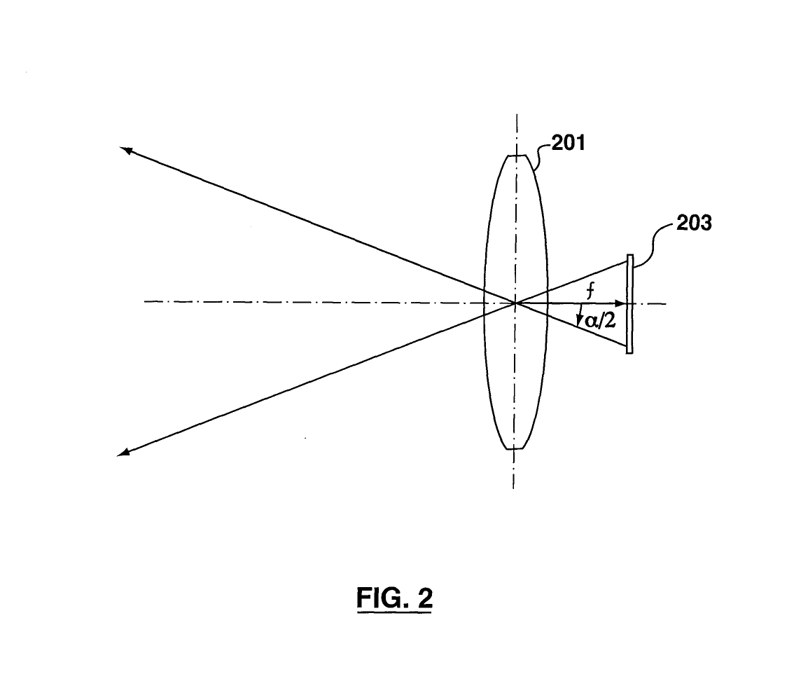

As previously described, the HMD may further comprise an imaging system configured to generate an image stream of the physical environment. The imaging system may comprise at least one camera 123 which provides the image stream of the physical environment to the processor 130 or directly to the display system 121. The processor 130 is configured to determine, for a given point in time, the field of view for the at least one camera 123 of the imaging system. As shown in FIG. 2, a lens 201 and an image sensor 203 for a camera are shown. The lens 201 and image sensor 203 are separated by the focal length f, which, in conjunction with the curvature of the lens 201, determines the field of view for the camera. The view angle a varies with the focal length f. It will be appreciated that the focal length f may be fixed or variable. Where the focal length is fixed, the processor may be preconfigured to determine the field of view for the camera. Where the focal length f is variable, however, the processor may obtain the focal length f or view angle a for the camera in substantially real-time.

When the camera captures an image stream of the physical environment, the captured physical image stream at any given moment will comprise elements of the physical environment lying within the field of view of the camera at that time.

The physical image stream obtained by the camera is either transmitted to the processor for processing and/or transmission to the display system, or directly to the display system for display to the user.

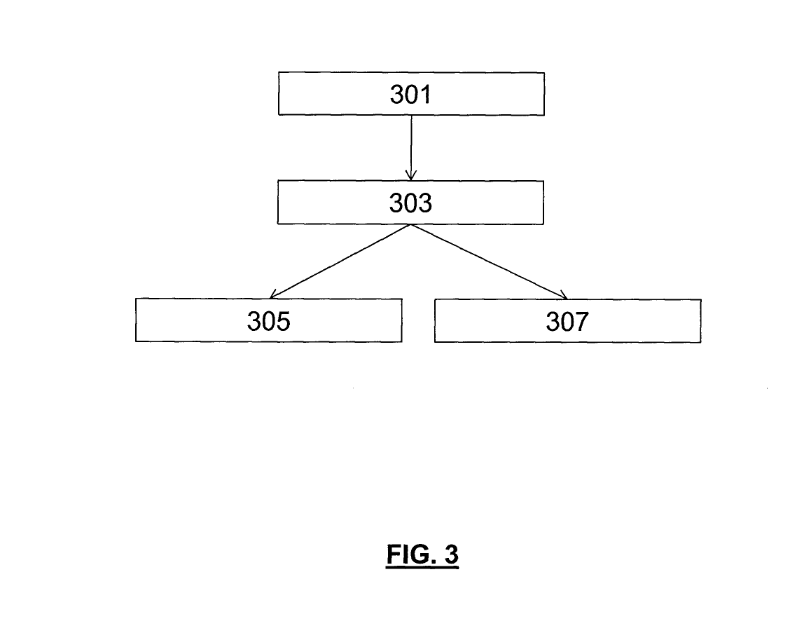

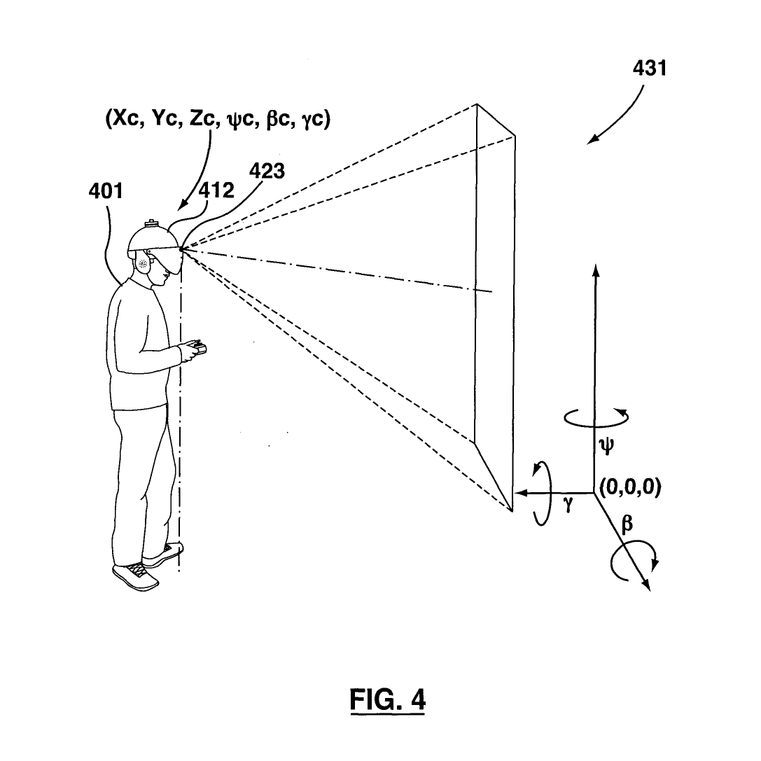

Referring now to FIG. 3, a method of overlapping the physical image stream with the rendered image stream is shown. At block 301, the processor determines the view field of view for the at least one camera in the imaging system, as previously described, as well as the location and orientation based on location and orientation information obtained from the local positioning and orientation detection systems of the HMD. The orientation and location of each camera may be estimated based on the location and orientation of the HMD or determined based on the location of the camera relative to the local positioning and orientation systems on the HMD. As shown in FIG. 4, a user 401 is equipped with an HMD 412 in a physical environment 431. The HMD 412 comprises an imaging system having at least one camera 423. The world-space coordinates X_{c}, Y_{c}, Z_{c} and orientation φ_{c}, β_{c}, γ_{c} of the camera are determined based on the location and orientation information generated by the local positioning and orientation determining systems.

Referring again to FIG. 3, at block 303, as previously mentioned, the processor generates a rendered image stream, which may be considered as being captured by a virtual or notional camera directed at the map of the physical environment, and associates the images of the virtual image stream with particular portions of the physical environment. The processor includes in the rendered image stream all rendered elements that would be visible within the field of view of the virtual camera. The processor may generate a rendered image stream which directly matches the physical image stream by displaying the rendered elements which would be visible within the field of view of a virtual camera having coordinates, orientation and field of view corresponding to the coordinates, orientation and field of view of the camera of the imaging system (recall that the processor associates the coordinates of the map to world coordinates when generating the map).

Alternatively, the processor may generate a rendered image stream that is offset, enlarged, reduced or which has a different aspect ratio by rendering elements in a region of the map that, respectively, is offset, enlarged or reduced, or that falls within a wider or narrower field of view than the corresponding region captured in the physical image stream.

At block 305, the processor transmits the rendered image stream to the display unit for display. In order to accurately match the rendered and physical image streams while the user is moving throughout the physical environment, the display system preferably receives a rendered image stream generated based substantially on the coordinates, orientation and field of view of the physical camera at the same time of capture as the portion of the physical image stream being displayed. If the fields of view of the virtual and physical cameras are substantially aligned and identical, simultaneous and combined display of both image streams provides a combined stream that is substantially matched. Alternatively, if the fields of view of the physical and virtual cameras are offset from each other, at block 307 the processor adjusts the screen coordinates (i.e., the coordinates on the display screen of the HMD) of the elements in the rendered image stream to align with the screen coordinates of the corresponding physical elements in the physical image screen. The processor determines screen coordinates for the physical image stream and the rendered image stream by invoking suitable view transformation techniques based on known parameters for the display system, and the determined orientation, location and field of view for each of the physical and virtual cameras. The processor transmits the adjusted rendered image stream to the display system substantially simultaneously, as described above with respect to block 307. Although the coordinates of the elements in each of the physical and virtual image streams will be substantially matched, only a partial overlay will be displayed. For example, if the virtual camera had a smaller field of view at block 303 than the physical camera, the overlaid image displayed on the display system will show a partial overlay in which the rendered image stream is only overlaid over a correspondingly smaller region of the physical image stream as displayed.

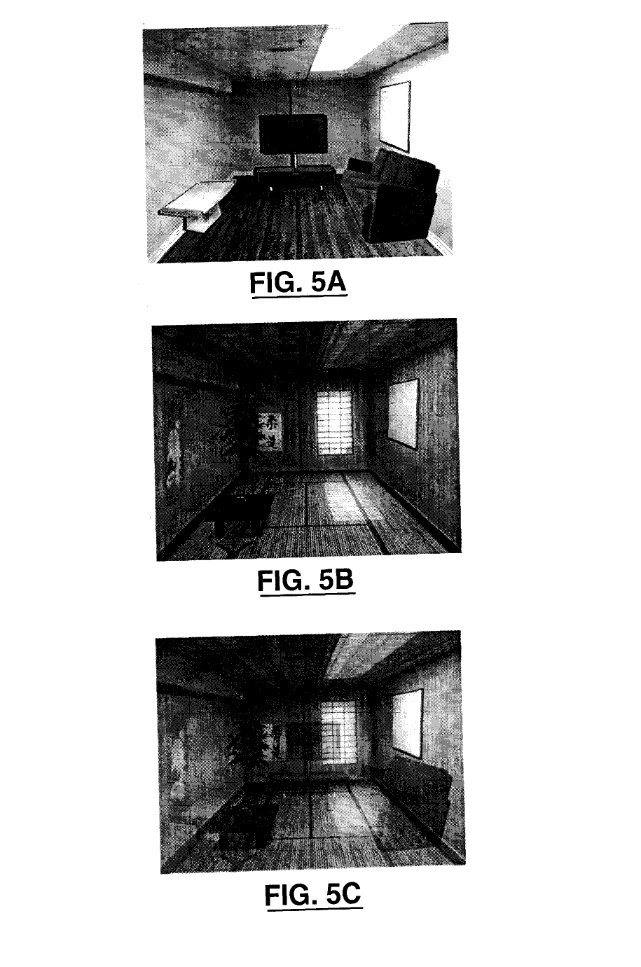

In embodiments, the processor may increase or decrease the signal strength of one or the other of the physical and rendered image streams to vary the effective transparency. Referring to FIGS. 5A to 5C, exemplary watermark overlays are illustrated. A frame in a physical image stream depicts a physical environment as captured by an imaging system of an HMD, as shown in FIG. 5A. FIG. 5B illustrates a corresponding frame of a rendered image stream of the physical environment. FIG. 5C illustrates a combined image stream in which the display simultaneously displays the corresponding frames of the rendered and physical image streams of FIGS. 5A and 5B. By increasing the strength of the physical stream and reducing the strength of the rendered image stream, the processor may increase the transparency of the rendered image stream, and vice versa.

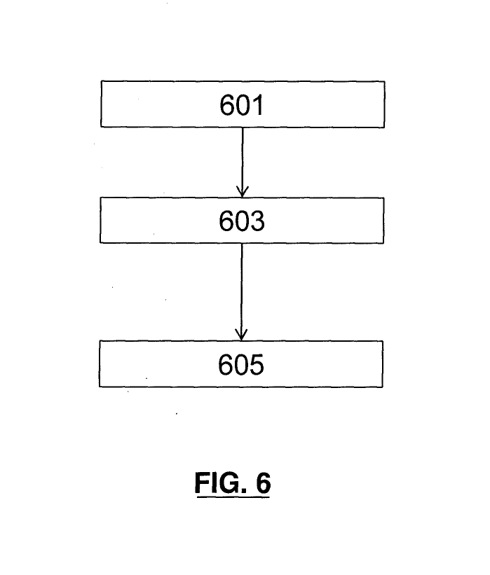

Referring now to FIG. 6, a method is described for substantially simultaneously displaying a rendered image stream and a physical image stream in PIP, picture-and-picture or other multi-picture format. The method invokes techniques which are analogous to the techniques described above with respect to FIG. 3. At step 601, the processor determines the field of view for the at least one camera in the imaging system, as previously described, as well as the location and orientation for the at least one camera based on location and orientation information obtained from the local positioning and orientation detection systems of the HMD

At block 603, the processor generates a rendered image stream captured by a virtual camera directed at the map of the physical environment. The processor includes in the rendered image stream all rendered elements that would be visible within the field of view of the virtual camera. The processor may generate a rendered image stream which directly matches the physical image stream by displaying the rendered elements which would be visible within the field of view of a virtual camera having coordinates, orientation and field of view corresponding to the coordinates, orientation and field of view of the camera of the imaging system (recall that the processor associates the coordinates of the map to world coordinates when generating the map).

Alternatively, the processor may generate a rendered image stream that is offset, enlarged, reduced or which has a different aspect ratio by rendering elements in a region of the map that, respectively, is offset, enlarged or reduced, or that falls within a wider or narrower field of view than the corresponding region captured in the physical image stream.

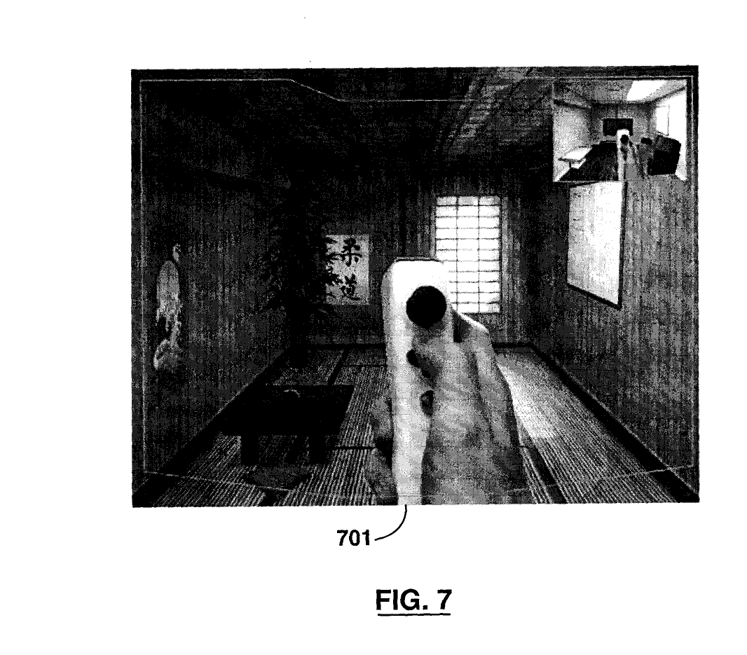

At block 605, the processor transmits the rendered image stream to the display unit for display. The processor and the display screen are configured to display, preferably selectively, the physical and rendered image streams substantially simultaneously, as previously described. However, in the present method, the two image streams are not overlaid; rather, the each stream is simultaneously displayed in a discrete region of the display system, for example, in PIP format, as shown in FIG. 7. Alternatively, both image streams are simultaneously displayed alongside each other on the same display screen, i.e., in picture-and-picture format, or each is simultaneously displayed on a separate screen, i.e., in multi-screen format.

Referring now to FIG. 7, a method is illustrated for displaying a physical image stream in the display system of an HMD in a pure VR application. As previously described, a pure VR application is one in which the rendered image stream is entirely unrelated to the physical environment in which the user is situated. Therefore, at block 701, the processor and the display system are configured to combine the rendered image stream and the captured physical image stream in any suitable format, such as, for example, picture-in-picture and picture-and-picture and multi-screen formats. It will be appreciated, then, that matching may be omitted, since the rendered image stream does not correspond to the physical environment.

In embodiments, the processor only causes the display system to display the physical image stream upon the user selecting display of the physical image stream. In further embodiments, the processor causes the display system to display the physical image stream in response to detecting proximity to an obstacle in the physical environment. In still further embodiments, the processor increases the transparency of the rendered image stream in response to detecting proximity to an obstacle in the physical environment. Conversely, the processor may reduce the transparency of the rendered image stream as the HMD moves away from obstacles in the physical environment.

In still further embodiments, the display system displays the physical and rendered image streams according to at least two of the techniques described herein.

Although the following has been described with reference to certain specific embodiments, various modifications thereto will be apparent to those skilled in the art without departing from the spirit and scope of the invention as outlined in the appended claims. The entire disclosures of all references recited above are incorporated herein by reference.

What is claimed is:

1. A method for simultaneously displaying, in a head mounted display disposed upon a user in a physical environment, a physical image stream of a captured region of the physical environment captured within the field of view an imaging system of the head mounted display, and an augmented reality rendered image stream generated by a processor for the physical environment, the method comprising:
(a) determining the captured region;
(b) generating a rendered image stream for a region of a map of the physical environment at least partially corresponding to the captured region;
(c) simultaneously receiving and displaying the physical image stream and the rendered image stream on a display system of the head mounted display.

2. The method of claim 1, further comprising translating, scaling and rotating the rendered image stream to align the region of the image stream corresponding to the captured region with the captured region.

3. The method of claim 2, wherein displaying comprises overlaying both image streams.

4. The method of claim 1, wherein the displaying comprises displaying the physical image stream in one region of the display system, and the rendered image stream in another region of the display system.

5. The method of claim 4, wherein the displaying comprises one of: picture-in-picture display, picture-and-picture display, and displaying each of the rendered image stream and the physical image stream on one screen of a multi-screen display.

6. The method of claim 1, wherein determining the captured region comprises determining, in substantially real time, an orientation and a location for the imaging system relative to the physical environment.

7. The method of claim 1, wherein the simultaneously displaying comprises more prominently displaying the physical image stream than the rendered image stream in response detecting proximity to an obstacle in the physical environment.

8. A system for matching an augmented reality rendered image stream to a physical image stream of a region of a physical environment captured in the field of view of an imaging system of a head mounted display, the system comprising a processor configured to:
(a) obtain a map of the physical environment;
(b) determine the captured region;
(c) generate a rendered image stream for a region of the map at least partially corresponding to the captured image stream.

9. The system of claim 8, wherein the processor is configured to translate, scale and rotate the rendered image stream to align the region in the rendered image stream corresponding to the captured region with the captured region.

10. The system of claim 1, wherein the processor determines the captured by obtaining, in substantially real-time, the field of view, orientation and location for the imaging system relative to the physical environment.
